(19) United States
(12) Patent Application Publication
(10) Pub. No.: US 2018/0170710 A1
(43) Pub. Date: Jun. 21, 2018

(54) ELEVATOR HOVER MODE OPERATION USING SENSOR-BASED POTENTIAL LOAD CHANGE DETECTION

(71) Applicant: Otis Elevator Company, Farmington, CT (US)

(72) Inventors: Michael A. Martin, East Hartford, CT (US); Bradley Armand Scoville, Farmington, CT (US)

(21) Appl. No.: 15/386,446

(22) Filed: Dec. 21, 2016

(51) Int. Cl. B66B 1/44; B66B 5/00; B66B 1/28

(52) U.S. Cl. CPC B66B 1/44; B66B 5/0018; B66B 2201/34; B66B 1/28; B66B 5/0012

(57) ABSTRACT

Methods and systems for controlling elevators are provided. The methods include detecting a potential load change using at least one sensor, the potential load change comprising detected passengers and/or cargo located on a landing, obtaining, at a computing system, potential load change information including the detected potential load change from the at least one sensor, determining if a hover mode of operation is required based on the potential load change information, and operating the elevator system in a hover mode of operation when it is determined that the hover mode of operation is required.

### BACKGROUND

The subject matter disclosed herein generally relates to elevator systems and, more particularly, to elevator systems configured to operate a hover mode of operation based on sensor-based potential load change detection.

An elevator system typically includes a plurality of belts or ropes (load bearing members) that move an elevator car vertically within a hoistway or elevator shaft between a plurality of elevator landings. When the elevator car is stopped at a respective one of the elevator landings, changes in magnitude of a load within the car can cause changes in vertical position of the car relative to the landing. The elevator car can move vertically down relative to the elevator landing, for example, when one or more passengers and/or cargo move from the landing into the elevator car. In another example, the elevator car can move vertically up relative to the elevator landing when one or more passengers and/or cargo move from the elevator car onto the landing. Such changes in the vertical position of the elevator car can be caused by soft hitch springs and/or stretching and/or contracting of the load bearing members, particularly where the elevator system has a relatively large travel height and/or a relatively small number of load bearing members. Under certain conditions, the stretching and/or contracting of the load bearing members and/or hitch springs can create disruptive oscillations in the vertical position of the elevator car, e.g., an up and down “bounce” motion.

### BRIEF SUMMARY

According to some embodiments, methods of controlling elevator systems are provided. The methods include detecting a potential load change using at least one sensor, the potential load change comprising detected passengers and/or cargo located on a landing, obtaining, at a computing system, potential load change information including the detected potential load change from the at least one sensor, determining if a hover mode of operation is required based on the potential load change information, and operating the elevator system in a hover mode of operation when it is determined that the hover mode of operation is required.

In addition to one or more of the features described herein, or as an alternative, further embodiments of the methods may include detecting a current load within an elevator car, wherein the potential load change information includes at least a portion of the detected current load, wherein the at least a portion of the detected current load comprises an estimation of the amount of load that will exit the elevator car at a next stop.

In addition to one or more of the features described herein, or as an alternative, further embodiments of the methods may include that the hover mode of operation comprises detecting a vertical position of an elevator car within an elevator shaft relative to a landing and controlling an elevator machine to maintain the vertical position of the elevator car within the elevator shaft.

In addition to one or more of the features described herein, or as an alternative, further embodiments of the methods may include operating the elevator system in a normal mode of operation when it is determined that the hover mode of operation is not required.

In addition to one or more of the features described herein, or as an alternative, further embodiments of the methods may include that the determination regarding the hover mode of operation comprises estimating a potential change in load based on the detected potential load change from the at least one sensor, wherein the estimated potential load change includes an estimated change in load that will transfer from the landing onto the elevator car.

In addition to one or more of the features described herein, or as an alternative, further embodiments of the methods may include comparing the estimated change in load that will transfer to a threshold value.

In addition to one or more of the features described herein, or as an alternative, further embodiments of the methods may include that the threshold value is a predetermined value such that at any values above the threshold value, car displacement will exceed a specified stopping tolerance and hovering mode will be activated and any values below the threshold value, car displacement will not exceed the specified stopping tolerance and hovering mode will not be activated.

In addition to one or more of the features described herein, or as an alternative, further embodiments of the methods may include the potential load change information further includes information received from one or more elevator car sensors located on the elevator car, wherein the one or more elevator car sensors are configured to detect the presence of passengers and/or cargo located within the elevator car.

In addition to one or more of the features described herein, or as an alternative, further embodiments of the methods may include detecting a current landing of the elevator car and the determination regarding the hover mode of operation is further based on the detected current landing.

According to some embodiments, elevator hover mode control systems are provided. The elevator hover mode control systems include an elevator machine operably connected to an elevator car located within an elevator shaft, at least one sensor configured to detect a potential load change comprising detected passengers and/or cargo located on a landing, a computing system in communication with the at least one sensor and configured to obtain potential load change information including the detected potential load change from the at least one sensor, and the computing system is further configured to determine if a hover mode of operation is required based on the potential load change information and control the elevator machine in a hover mode of operation when it is determined that the hover mode of operation is required.

In addition to one or more of the features described herein, or as an alternative, further embodiments of the elevator hover mode control systems may include that the elevator shaft includes a plurality of landings, wherein each landing has at least one respective sensor located thereon and configured to detect the presence of passengers and/or load, wherein each respective sensor is in communication with the computing system.

In addition to one or more of the features described herein, or as an alternative, further embodiments of the elevator hover mode control systems may include at least one load detector within the elevator car, wherein the potential load change information includes at least a portion of the detected current load, wherein the at least a portion of the detected current load comprises an estimation of the amount of load that will exit the elevator car at a next stop.

In addition to one or more of the features described herein, or as an alternative, further embodiments of the elevator hover mode control systems may include that the hover mode of operation includes detecting a vertical position of an elevator car within an elevator shaft relative to a landing and controlling the elevator machine to maintain the vertical position of the elevator car within the elevator shaft.

In addition to one or more of the features described herein, or as an alternative, further embodiments of the elevator hover mode control systems may include that the computing system is configured to operate the elevator system in a normal mode of operation when it is determined that the hover mode of operation is not required.

In addition to one or more of the features described herein, or as an alternative, further embodiments of the elevator hover mode control systems may include that the determination regarding the hover mode of operation includes estimating a potential change in load based on the detected potential load change from the at least one sensor, wherein the estimated potential load change includes an estimated change in load that will transfer from the landing onto the elevator car.

In addition to one or more of the features described herein, or as an alternative, further embodiments of the elevator hover mode control systems may include that the computing system is further configured to compare the estimated change in load that will transfer to a threshold value.

In addition to one or more of the features described herein, or as an alternative, further embodiments of the elevator hover mode control systems may include that the threshold value is a predetermined value such that at any values above the threshold value, car displacement will exceed a specified stopping tolerance and hovering mode will be activated and any values below the threshold value, car displacement will not exceed the specified stopping tolerance and hovering mode will not be activated.

In addition to one or more of the features described herein, or as an alternative, further embodiments of the elevator hover mode control systems may include one or more elevator car sensors located on the elevator car configured to detect the presence of passengers and/or cargo located within the elevator car, wherein the potential load change information further includes information received from the one or more elevator car sensors.

In addition to one or more of the features described herein, or as an alternative, further embodiments of the elevator hover mode control systems may include a landing detection sensor configured to detect a current landing of the elevator car and the determination regarding the hover mode of operation is further based on the detected current landing.

In addition to one or more of the features described herein, or as an alternative, further embodiments of the elevator hover mode control systems may include that the sensor is at least one of a visual detection sensor or a time of flight depth sensor.

Technical effects of embodiments of the present disclosure include elevator systems configured to determine and activate hover mode based on detection and estimation of potential load changes that originate at a landing. Further technical effects include visually detecting a potential load change at a landing within a building and determining to activate a hover mode of operation based on the visual detection.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 is a schematic block diagram illustrating a computing system that may be configured for one or more embodiments of the present disclosure;

FIG. 3 is a schematic illustration of an elevator car configured in accordance with an embodiment of the present disclosure;

FIG. 4 is a schematic illustration of landing of an elevator system configured in accordance with an embodiment of the present disclosure; and

FIG. 5 is a flow process for controlling an elevator system in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure in which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

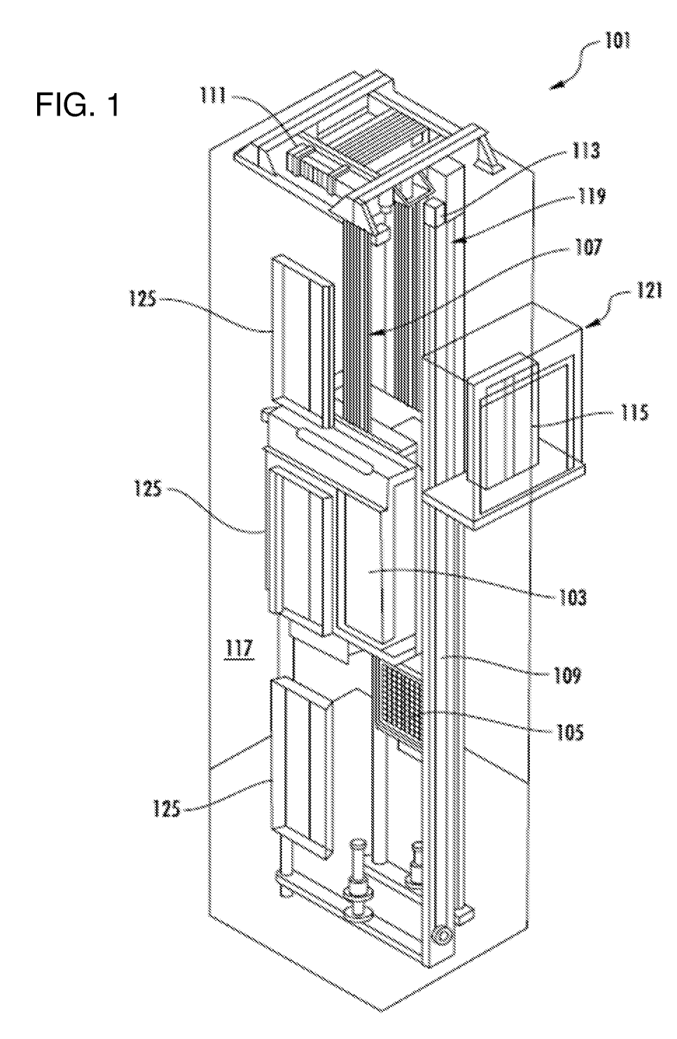

FIG. 1 is a perspective view of an elevator system 101 including an elevator car 103, a counterweight 105, one or more load bearing members 107, a guide rail 109, a machine 111, a position encoder 113, and an elevator controller 115. The elevator car 103 and counterweight 105 are connected to each other by the load bearing members 107. The load bearing members 107 may be, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The load bearing members 107 engage the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101. In some embodiments, the elevator controller 115 can be configured to control features within the elevator car 103, including, but not limited to, lighting, display screens, music, spoken audio words, etc.

The machine 111 may include a motor or similar driving mechanism and an optional braking system. In accordance with embodiments of the disclosure, the machine 111 is configured to include an electrically driven motor. The power supply for the motor may be any power source, including a power grid, which, in combination with other components, is supplied to the motor. Although shown and described with a rope-based load bearing system, elevator systems that employ other methods and mechanisms of moving an elevator car within an elevator shaft, such as hydraulics or any other methods, may employ embodiments of the present disclosure. FIG. 1 is merely a non-limiting example presented for illustrative and explanatory purposes.

Embodiments provided herein are directed to apparatuses, systems, and methods related to elevator control at a landing, and particularly to an elevator “hover mode.” An elevator hover mode is a mode of operation that is used at landings when an elevator car may move up or down (e.g., bounce) due to load changes and/or extension/contraction of load bearing members (e.g., a continuous re-levelling feature). According to embodiments provided herein, an elevator system can enter or operate within a hover mode of operation based on detected and/or anticipated potential load changes. For example, an elevator system in accordance with embodiments of the present disclosure can preemptively enter a hover mode based on detection of passengers that are at a landing waiting to enter an elevator car that will be arriving at the landing. Alternatively, in some embodiments, when the elevator system detects or anticipates that a load will exit the elevator car, the hover mode can be preemptively activated. Such activation of the hover mode, in accordance with embodiments of the present disclosure can be used to provide a smooth elevator experience to passengers that are on the elevator and passengers that are exiting or entering the elevator car. That is, bounce or movement of the elevator car can be mitigated even during load changes to and/or from the elevator car.

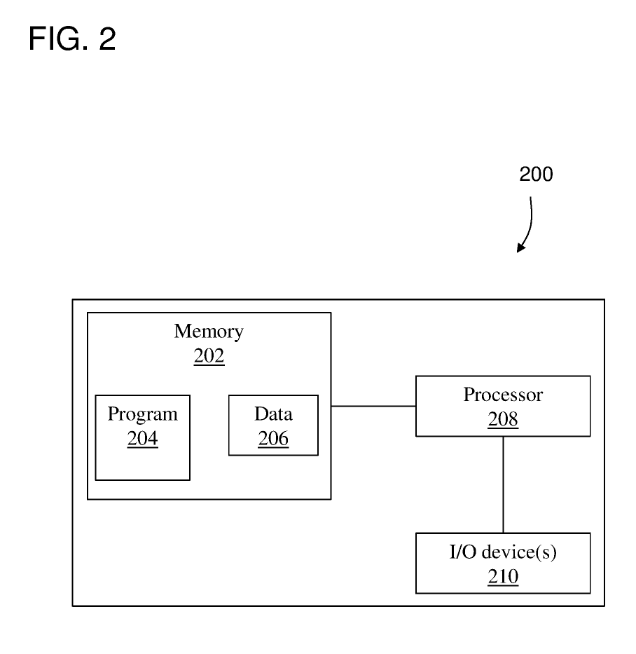

Referring now to FIG. 2, an exemplary computing system 200 that can be incorporated into elevator systems of the present disclosure is shown. The computing system 200 may be configured as part of and/or in communication with an elevator controller, e.g., controller 115 shown in FIG. 1, and/or as part of a hover mode control system as described herein. The computing system 200 includes a memory 202 which can store executable instructions and/or data associated with the hover mode control system. The executable instructions can be stored or organized in any manner and at any level of abstraction, such as in connection with one or more applications, processes, routines, procedures, methods, etc. As an example, at least a portion of the instructions are shown in FIG. 2 as being associated with a hover mode control program 204.

Further, as noted, the memory 202 may store data 206. The data 206 may include, but is not limited to, elevator car data, elevator modes of operation, commands, or any other type(s) of data as will be appreciated by those of skill in the art. The instructions stored in the memory 202 may be executed by one or more processors, such as a processor 208. The processor 208 may be operative on the data 206.

The processor 208, as shown, is coupled to one or more input/output (I/O) devices 210. In some embodiments, the I/O device(s) 210 may include one or more of a keyboard or keypad, a touchscreen or touch panel, a display screen, a microphone, a speaker, a mouse, a button, a remote control, a joystick, a printer, a telephone or mobile device (e.g., a smartphone), a sensor, etc. The I/O device(s) 210, in some embodiments, include communication components, such as broadband or wireless communication elements.

The components of the computing system 200 may be operably and/or communicably connected by one or more buses. The computing system 200 may further include other features or components as known in the art. For example, the computing system 200 may include one or more transceivers and/or devices configured to transmit and/or receive information or data from sources external to the computing system 200 (e.g., part of the I/O devices 210). For example, in some embodiments, the computing system 200 may be configured to receive information over a network (wired or wireless) or through a cable or wireless connection with one or more devices remote from the computing system 200 (e.g. direct connection to an elevator machine, etc.). The information received over the communication network can stored in the memory 202 (e.g., as data 206) and/or may be processed and/or employed by one or more programs or applications (e.g., program 204) and/or the processor 208.

The computing system 200 is one example of a computing system, controller, and/or control system that is used to execute and/or perform embodiments and/or processes described herein. For example, the computing system 200, when configured as part of an elevator control system, is used to receive commands and/or instructions and is configured to control operation of an elevator car through control of an elevator machine. For example, the computing system 200 can be integrated into or separate from (but in communication therewith) an elevator controller and/or elevator machine and operate as a portion of a hover mode control system. As used herein, the term “hover mode control system” refers to one or more components configured to control movement and, particularly, a hover mode of an elevator car, as described below.

The computing system 200 is configured to operate and/or control a hover mode of an elevator. The hover mode of operation is used to mitigate or significantly reduce elevator car bounce. Such elevator car bounce may be a result of long load bearing members (e.g., belts, ropes, cables, or other suspension mechanism) used to suspend and move the elevator car within an elevator shaft and/or as a result of changes in elevator car load (e.g., changes in weight pulling on the load bearing members). For example, in high-rise buildings, due to the length of the load bearing members, a suspended elevator car may bounce or move slightly when at a landing. Such effects may be observed in high rise elevator systems (e.g., systems within tall buildings) when the elevator car is at a relatively low landing (e.g., close to the ground floor of the building). In such instances, the load bearing members can be sufficiently extended and long that extension (e.g., stretching) or contraction of the load bearing members may occur. Such extension or contraction can cause the elevator car to move relative to a stopped position, even if brakes are engaged to prevent movement of the elevator car. That is, the movement of the elevator car can be independent of the operation of the machine that drives movement of the elevator car within the elevator shaft.

For example, an elevator typically includes a plurality of load bearing members that are driving by an elevator machine to move an elevator car vertically within a hoistway or elevator shaft between a plurality of elevator landings (see, e.g., FIG. 1). When the elevator car is stopped at a respective one of the elevator landings, changes in magnitude of a load within the car (e.g., changes in weight) can cause changes in vertical position of the car relative to the landing. For example, the elevator car can move vertically down relative to the elevator landing when one or more passengers and/or cargo move from the landing into the elevator car (e.g., positive load change). In another example, the elevator car can move vertically up relative to the elevator landing when one or more passengers and/or cargo move from the elevator car onto the landing (e.g., negative load change). The term “load change” as used herein includes persons, objects, cargo, things, etc. that may be loaded onto (e.g., enter) or unloaded from (e.g., exit) an elevator car. A positive load change is an increase in weight that is suspended by the load bearing members and a negative load change is a decrease in weight that is suspended by the load bearing members.

Such changes in the vertical position of the elevator car can be caused by soft hitch springs, stretching and/or contracting of the load bearing members, and/or for various other reasons, particularly where the elevator system has a relatively large travel height and/or a relatively small number of load bearing members. Under certain conditions, the stretching and/or contracting of the load bearing members and/or hitch springs can create disruptive oscillations in the vertical position of the elevator car; e.g., an up and down motion of the elevator car.

In accordance with embodiments of the present disclosure, the elevator machine is controlled by the hover mode control system in a “hover mode” to mitigate the above described movement/bounce. For example, the computing system 200 within an elevator controller signals the elevator machine to lift or otherwise disengage the brake of the elevator machine and thus the load bearing members are moveable by operation of a motor of the elevator machine. The hover mode control system thereafter utilizes one or more sensors and the motor in a feedback loop to move an elevator machine or portion thereof, such as a traction sheave, and thus maintain a constant vertical position of the elevator car within the hoistway after accounting for stretching and/or contracting of the load bearing members. The sensors, for example, provide sensor signals to the controller. The controller subsequently signals the motor, via a second control signal, to move the elevator machine. By moving the elevator machine the motor may substantially counteract stretching and/or contracting of the load bearing members and, thus, prevent the elevator car from moving vertically within the hoistway (i.e., hovering at a landing). As will be appreciated by those of skill in the art, a function of a hover mode operation is to place the elevator system in a state of continuous re-levelling, so that a specified stopping tolerance (e.g., +/−3 mm) can be maintained at the floor in the presence of changing car load and/or other hoistway dynamics.

During the hover mode, one or more passengers and/or cargo may move between the elevator car and the elevator landing without experiencing a change in elevator car position. The change in load may change a magnitude of an overall load (e.g., weight) of the elevator car and thus suspended by the load bearing members. The movement therefore may also cause the load bearing members (e.g., ropes, belts, cables, etc.) supporting the weight of the elevator car to longitudinally stretch and/or contract in a dynamic manner. The load bearing members may stretch, for example, where passengers and/or cargo move from the elevator landing into the elevator car because the weight of the passengers and/or cargo is added to the weight of the elevator car (and any already present passengers/cargo). Alternatively, the load bearing members may contract when passengers and/or cargo move from the elevator car onto the elevator landing because the weight of the passengers and/or the cargo is subtracted from the overall weight of the elevator car.

As noted, under certain conditions, the stretching and/or contracting of the load bearing members may cause the elevator car to vertically oscillate or bounce (e.g., move up and down) relative to the elevator landing. Hover mode control systems, as provided herein, however, are configured to reduce or substantially prevent the vertical oscillations or bounce of the elevator car using the feedback loop employed in a hover mode of operation.

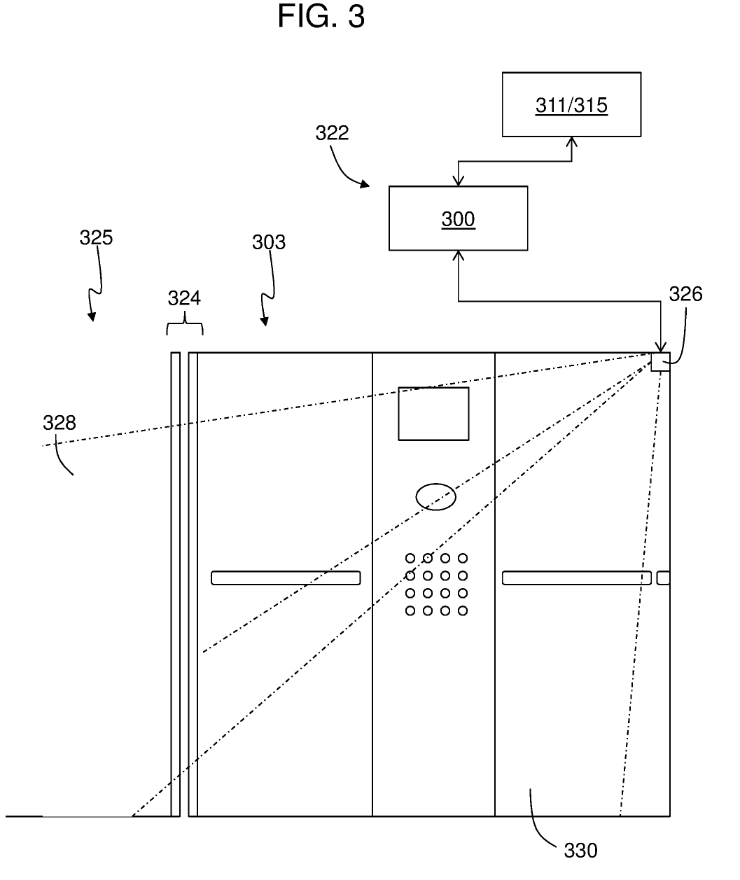

Turning now to FIG. 3, a schematic illustration of a hover mode control system 322 in accordance with an embodiment of the present disclosure is shown. The hover mode control system 322 is a mechanism for an elevator system to detect passengers within and outside of an elevator car 303 and use such detection to operate and control a hover mode. As shown in FIG. 3, the elevator car 303 is positioned at a landing 325 with elevator doors 324 that include elevator car doors and landing doors. The elevator doors 324 are openable when the elevator car 303 is located at the landing 325. With the elevator doors 324 open, passengers and/or cargo may exit or enter the elevator car 303. During the entering and/or exiting, the load of the elevator car 303 will change, which can result in bounce, as described above. This can be compensated for (preemptively) through operation of the hover mode control system 322.

As shown, the hover mode control system 322 includes a computing system 300, an elevator controller 315 and elevator machine 311, and one or more sensors 326. The elevator machine 311 is operably connected to and controls one or more load bearing members (not shown) that suspend and control movement of the elevator car 303 within an elevator shaft. The elevator machine 311 includes a braking mechanism that is used to stop movement of the elevator machine 311 (or a portion thereof) and, thereby, the load bearing members. Accordingly, movement of the elevator car 303 within the elevator shaft may be stopped. The braking mechanism, in normal operation, is controlled to engage when the elevator car 303 stops at a landing (e.g., landing 325) and enables passengers and/or cargo to be safely loaded and/or unloaded between the landing 325 and the elevator car 303. However, if the hover mode control system 322 determines that hover mode is required or necessary, the brakes will not be engaged, and the hover mode control system 322 will control the elevator machine 311 to maintain the elevator car 303 at a specific vertical position within the elevator shaft, even when the load within the elevator car 303 changes.

The sensor(s) 326 of the hover mode control system 322 are configured to detect persons and/or cargo (e.g., a potential load change) located within the elevator car 303 and/or located on the landing 325. The term “potential load change,” as used herein, includes persons, objects, cargo, things, etc. that may be loaded on to (e.g., enter) or unloaded from (e.g., exit) the elevator car 303. The sensor(s) 326 are cameras or other similar detection devices. Those of skill in the art will appreciate that additional or alternative types of detection sensors may be used without departing from the scope of the present disclosure, including, but not limited to, infrared and/or proximity sensors. Another example of a sensor that may be employed in embodiments of the present disclosure is a time of flight depth sensor. In such sensor, output is not visual but rather is an array of depth/distance values. The array may be viewed as a two dimensional image with each pixel representing a grayscale value from which depth and time of flight may be extracted, as known in the art.

As shown in FIG. 3, a single sensor 326 is located within the elevator car 303. The sensor 326 is positioned such that it can detect the presence of persons or objects within the elevator car 303 and on the landing 325 (when the elevator doors 324 are open). For example, the sensor 326 is configured to detect a first detection region 328 located on the landing 325 outside the elevator car 303 and a second detection region 330 located within the elevator car 303. In some embodiments, the first and second detection regions 328, 330 may be a single or continuous region of detection. In some such embodiments, various image or detection processing may be performed on a detection signal to determine if a detected person or object is within the elevator car 303 or on the landing 325.

In accordance with the non-limiting embodiment shown in FIG. 3, as a passenger approaches the elevator car 303 (or as the elevator car 303 arrives at the landing 325), the hover mode control system 322 employs the sensor 326 to detect the number and/or amount of passengers and/or cargo within the elevator car 303 and the number and/or amount of passengers and/or or cargo at the landing 325. For example, the sensor and an associated processor can estimate the load of objects based on size and/or volume and object identification. In such process, for example, a detected person with a particular detected size and/or volume can be used to extract, estimate, and/or determine a weight of the detected person. Similarly, when detecting a non-person object (e.g., a table, a cart, a hand-truck, etc.), the sensor and processor can estimate weight based on size and/or volume of the detected shape/object and estimate based on a typical material weight that is associated with the determined object. That is, the hover mode control system 322 makes a detection and determination regarding a potential load change based on the detected passengers/cargo. If a determination is made that the potential load change will exceed a predetermined value, the hover mode control system 322 activates the hover mode. Such determination may be made prior to the elevator car 303 arriving at the landing 325, and thus the hover mode can be preemptively activated to account for potential load changes and thus prevent bounce of the elevator car 303. As an example of a predetermined value (e.g., threshold value), if the detected and/or estimated net load change will exceed 35% of the car duty and the elevator car is positioned at a landing less than a specific floor (e.g., eighth floor), then the hover mode control system will anticipate that the hover mode operation will require activation. In general, the hover mode operation and activation will depend on the net load change in the elevator car and the expected amount change in hoistway dynamics (e.g., load bearing member stretch) given the current position of the elevator car within the elevator shaft.

As will be appreciated by those of skill in the art, image processing systems as employed with hover mode control systems of the present disclosure, can estimate the volume of an object, but may have difficulty estimating mass. However, in accordance with embodiments of the present disclosure, the image processing system of the hover mode control system can make use of a detected object gait profile (e.g., profile of a person walking) along with visual material properties of the detected object (e.g., is the detected object metallic, reflective, etc.) to generate a best estimate of a “go” or “no go” for the hover mode operation. The threshold for activation of the hover mode of operation can be configuration within the hover mode control systems of the present disclosure. For example, a threshold can be based on a percent of car duty or other parameters that may be job and/or operationally specific. In this way, even if the estimated mass of the object differs significantly from a true value, activation of the hover mode may be employed even if not actually required. Accordingly, in some embodiments, sensory information obtained from one or more sensors can be employed to generate a satisfactory estimate on whether a hover mode should be activated or not. In accordance with embodiments of the present disclosure, the threshold value is a predetermined value such that at any values above the threshold value car displacement will exceed a specified stopping tolerance (e.g., +/−3 mm) relative to a landing and hovering mode will be activated. Below the threshold value car displacement will not exceed the specified stopping tolerance and hovering mode will not be activated.

In some embodiments, the hover mode control system 322 and associated sensor 326 can identify objects and track movement of the objects over time. From this, a determination of intent to ride the elevator can be made. For example, a determination can be made whether the detected object is passing by or heading toward the elevator for boarding/loading. Such analysis and determination can be implemented in various ways. For example, the process and systems described in U.S. patent application Ser. No. 15/089,609, entitled “Depth sensor based passenger sensing for passenger conveyance control,” filed on Apr. 4, 2016, and/or described in U.S. patent application Ser. No. 15/089,612, entitled “Depth sensor based passenger sensing for passenger conveyance control,” filed on Apr. 4, 2016, both of which are incorporated herein in their entireties. In such embodiments and configurations, detected velocity of the object may be used to determine when the hover mode should be activated. For example, such preemptive determination and activation of a hover mode can be used to prevent a tripping hazard due to an offset elevator car relative to a landing.

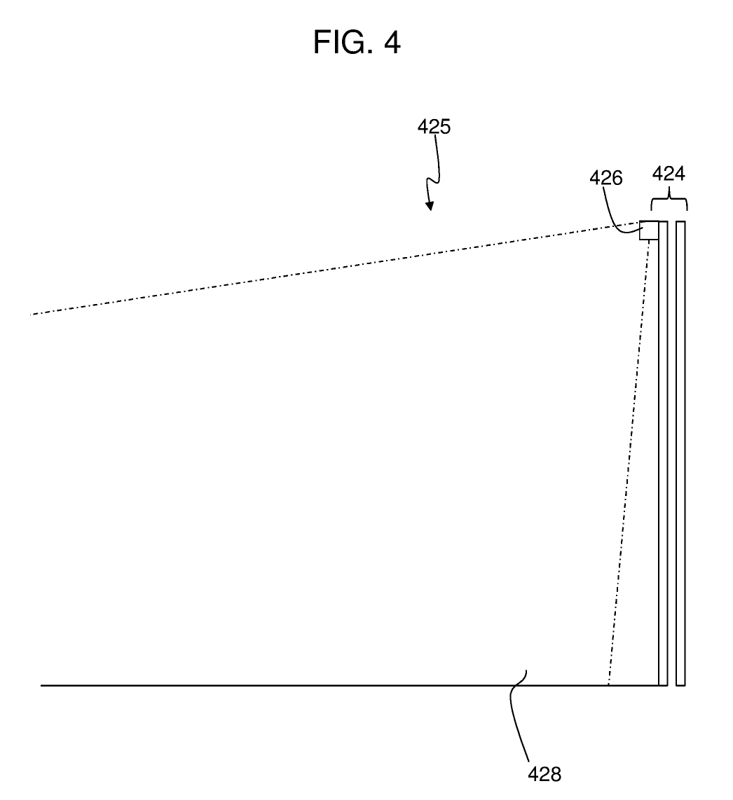

Turning now to FIG. 4, an alternative configuration of a sensor of a hover mode control system in accordance with an embodiment of the present disclosure is shown. The hover mode control system of the embodiment of FIG. 4 is substantially similar to that shown and described above with respect to FIG. 3 and thus similar features are not shown for simplicity. However, as shown in FIG. 4, a sensor 426 of the hover mode control system is located above elevator doors 424 and on the landing 425 (as compared to being located within the elevator car). The location of the sensor 426 is not to be limited to the position shown, but rather can be locate anywhere on or near the landing 425 and elevator doors 424 to provide detection and information related to potential load changes.

In addition to the embodiments shown in FIGS. 3-4, various other configurations and orientations are possible without departing from the scope of the present disclosure. For example, in some embodiments, multiple sensors can be employed, including, but not limited to, a first sensor located on or at the landing (e.g., outside the elevator car) and a second sensor located within the elevator car. Further, in some embodiments, multiple visual or other type-sensors can be located at both locations described above to provide adequate and/or accurate information to make potential load change determinations. For example, a combination of visual, infrared, proximity, time-of-flight arrays, and weight sensors can all be used in embodiments of the present disclosure. Each of the sensors can be in communication with a computing system to enable control as described herein.

In operation, the hover mode control system is configured to perform a detection using, at least, the sensor(s), make a determination regarding potential load change using a processor, and activate a hover mode of operation using the processor and communication and control with and of the elevator machine. The detection can be made of potential load change elements (e.g., people, cargo, etc.) located at a landing, e.g., waiting at the landing proximate elevator doors, approaching the elevator doors, etc. Similarly, in some embodiments, the detection can be made of potential load change elements located on the elevator car. Based on a detected potential load change, the hover mode control system will determine if hover mode should be activated and when such mode should be activated based on movement detection (e.g., velocity detection). Various factors can be considered in this determination. For example, the hover mode control system can consider potential load increase and/or potential load decrease (based on detected potential load change), actual load information (e.g., weight sensors on elevator car), landing that is being approached, length of load bearing members (e.g., distance from machine to landing being approached), and/or other factors. If the considerations satisfy one or more predetermined thresholds and/or requirements, the hover mode will be activated. For example, a threshold value may be a weight value that is based on a current known load value plus a determination that a net change in load will be positive (e.g., detection that multiple people will be entering the elevator car at the landing). An example of a predetermined requirement may be a specific landing, such as the lowest five landings of a building, wherein it is known that the length of the load bearing members will be of sufficient length to cause bounce. In such a case, the hover mode may always be activated, even if the potential load change is small and would not otherwise require hover mode.

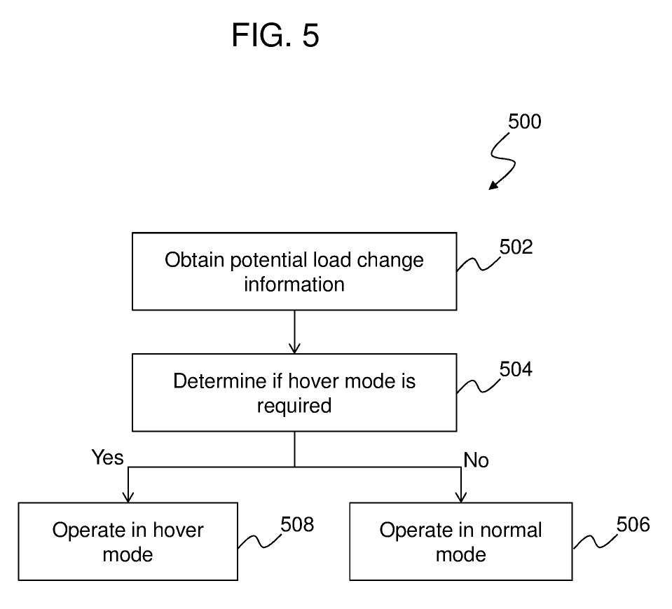

Turning now to FIG. 5, a flow process 500 in accordance with an embodiment of the present disclosure is shown. The flow process 500 can be performed by a hover mode control system as shown and described herein and/or by variations thereon. Various aspects of the flow process 500 can be carried out using one or more sensors, one or more processors, and/or one or more machines and/or controllers. For example, some aspects of the flow process involve sensor(s), as described above, that are in communication with a processor or other control device and transmit detection information thereto. The control device or processor can then analyze detection information to determine a potential load change along with other system information (e.g., landing floor number, current elevator load, etc.). Based on the potential load change, the control device or processor will determine if a hover mode should be activated or not.

For example, at block 502, potential load change information is obtained. Potential load change information includes, at least, a detection of potential load change based on passengers and/or cargo that are on a landing where an elevator is called. A sensor (or other type of sensor) can be used to detect objects (e.g., passengers and/or cargo) that are waiting in proximity to an elevator door at a landing to which an elevator will be arriving. Further, the sensor can be used to monitor and/or detect potential passengers and/or cargo that are moving toward the elevator doors, as described in the applications incorporated above. In the latter case, a timer or time-stamp can be applied to indicate that the potential passenger/cargo is estimated to arrive in a given time or at a given time. The time aspect can be used to determine if the potential passenger/cargo will arrive at the elevator doors in sufficient time for the current elevator to carry said potential passenger/cargo. In some embodiments, the detection includes a determination of the number of potential passengers and/or size of a cargo that are waiting or approaching the elevator doors. In one non-limiting example, the hover mode control system can obtain “intent” based information from activation of a car call button (located inside the car) for a given destination floor, information from a destination entry system that is installed within the building, with a detection system located inside the elevator car, and/or using visual detection of the movement of one or more passengers toward the elevator car door at the landing, as the car approaches the respective landing floor.

At block 502, additional potential load change information can be obtained. The additional potential load change information can include, for example, a detection of the passengers/cargo currently located within the elevator car (e.g., using a sensor as described above). Other additional potential load change information can include a current weight or load of the elevator car, with such information obtained from weight or load sensors located on the elevator car, attached to the load bearing members, and/or connected to the elevator machine.

At block 504, based on the potential load change information obtained at block 502, a processor of the hover mode control system is used to determine if hover mode is required. The determination is based on, at least, a comparison of a potential load change with a threshold value. The threshold value can be different for each landing within a building, for example, with landings lower in the building having lower thresholds than landings higher in the building. That is, a smaller change in load can have a greater effect the lower the landing is within a building, and thus a threshold value will be lower for the lower landings. In alternative configurations, a single threshold can be set for all landings that are at or below a specified landing (e.g., the lowest five or ten landings within a building). Further still, in some embodiments, groupings of landings can be set with different threshold values. The values may be a total load or weight that if exceeded, the elevator car may experience bounce, and thus hover mode should be activated. For example, if the potential load change information indicates a large increase (e.g., detection of seven people waiting and/or walking toward elevator doors) this may indicate potential bouncing of the elevator car, and thus hover mode is required. However, if the potential load change is estimated to be small (and below the threshold) hover mode is not required.

Although various thresholds and types thereof may be employed in accordance with embodiments of the present disclosure, a few examples are provided as follows. For example, the threshold can be based on specific, identified and/or pre-selected floors. In such an example, if a destination floor is at or lower than the preselected threshold landing, then the hover mode control system is configured to anticipate that hover mode operation will be required. Further, a combination of destination floor and the current load/capacity of the elevator car can be employed to establish a threshold. In such example, if the elevator car is initially close to fully loaded (>90% of maximum capacity) and the destination floor is the lobby during the evenings, the hover mode control system can be configured to anticipate operation of the hover mode. Further, such thresholds can incorporate temporal or time-based information. For example, if the elevator car is initially empty and the destination floor is the lobby and it is during peak service hours, the hover mode operation may be anticipated by the hover mode control system. In another example, if there is a given floor in a building that is designated for independent service (e.g., service elevator) where it is anticipated that a lot of heavy goods (e.g., loads approaching car duty or maximum capacity) will be added to or removed from the car, then the hover mode control system can be configured to anticipate use of the hover mode of operation.

In some embodiments, as noted, the potential load change information can include additional information, such as current load of the elevator car. In such an embodiment, the threshold may not be only a delta change (as described above), but rather can be a total load after the change. For example, if an elevator car is empty, and thus at minimum load, when the passengers/cargo enter the car during loading, the elevator car may not be subject to bouncing, and thus hover mode is not required.

In other embodiments, such as intelligent elevator systems, the hover mode control system may be provided with information regarding the present passengers of the elevator car. For example, passengers may preset their destination floors within a building, and this information can be provided to the hover mode control system. Based on this information, the hover mode control system can estimate the amount of load that will be exiting the elevator car, and thus a change in load based on loading and unloading can be made, and such information can be compared to a threshold load of the elevator car, and used to determine if hover mode is required.

If, based on the above information obtained in blocks 502, 504, it is determined that hover mode is not required, the flow process 500 keeps the elevator system in normal operation mode, as shown at block 506. Normal operation mode may include use of a brake mechanism at the elevator machine when the elevator car is stopped at a landing.

However, based on the above information obtained in blocks 502, 504, if it is determined that hover mode is required, the flow process 500 proceeds to block 508 and the elevator system is controlled and operated in a hover mode of operation. The hover mode operation can be maintained until the elevator car doors close and the elevator is returned to the normal mode of operation when traveling to another landing, as will be appreciated by those of skill in the art. However, as the elevator car approaches the next landing/stop, the flow process 500 is repeated.

Advantageously, embodiments of the present disclosure provide a hover mode control systems and methods of control that can enable a hover mode only when needed. That is, embodiments provided herein can estimate and anticipate a change in load that will occur when an elevator car is at a landing and can determine if hover mode is needed or not. Advantageously, this can provide a smooth experience to persons loading and unloading from the elevator car. Further, such system can appropriate compensate for stretching or bounce of an elevator car. Such systems and processes can be used even at landings that are high within a building, such as when a very large change in carried load is anticipated. Thus, embodiments of the present disclosure are not limited to merely “high-rise” or tall buildings, but can be equipped on any elevator system.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method of controlling an elevator system, the method comprising:
detecting a potential load change using at least one sensor, the potential load change comprising detected passengers and/or cargo located on a landing;
obtaining, at a computing system, potential load change information including the detected potential load change from the at least one sensor;
determining if a hover mode of operation is required based on the potential load change information; and
operating the elevator system in a hover mode of operation when it is determined that the hover mode of operation is required.

2. The method of claim 1, further comprising detecting a current load within an elevator car, wherein the potential load change information includes at least a portion of the detected current load, wherein the at least a portion of the detected current load comprises an estimation of the amount of load that will exit the elevator car at a next stop.

3. The method of claim 1, wherein the hover mode of operation comprises:
detecting a vertical position of an elevator car within an elevator shaft relative to a landing; and
controlling an elevator machine to maintain the vertical position of the elevator car within the elevator shaft.

4. The method of claim 1, further comprising operating the elevator system in a normal mode of operation when it is determined that the hover mode of operation is not required.

5. The method of claim 1, wherein the determination regarding the hover mode of operation comprises:
estimating a potential change in load based on the detected potential load change from the at least one sensor, wherein the estimated potential load change includes an estimated change in load that will transfer from the landing onto the elevator car.

6. The method of claim 5, further comprising comparing the estimated change in load that will transfer to a threshold value.

7. The method of claim 6, wherein the threshold value is a predetermined value such that at any values above the threshold value, car displacement will exceed a specified stopping tolerance and hovering mode will be activated and any values below the threshold value, car displacement will not exceed the specified stopping tolerance and hovering mode will not be activated.

8. The method of claim 1, wherein the potential load change information further includes information received from one or more elevator car sensors located on the elevator car, wherein the one or more elevator car sensors are configured to detect the presence of passengers and/or cargo located within the elevator car.

9. The method of claim 1, further comprising:
detecting a current landing of the elevator car; and
the determination regarding the hover mode of operation is further based on the detected current landing.

10. An elevator hover mode control system comprising:
an elevator machine operably connected to an elevator car located within an elevator shaft;
at least one sensor configured to detect a potential load change comprising detected passengers and/or cargo located on a landing;
a computing system in communication with the at least one sensor and configured to obtain potential load change information including the detected potential load change from the at least one sensor;
the computing system further configured to determine if a hover mode of operation is required based on the potential load change information and control the elevator machine in a hover mode of operation when it is determined that the hover mode of operation is required.

11. The elevator hover mode control system of claim 10, wherein the elevator shaft includes a plurality of landings, wherein each landing has at least one respective sensor located thereon and configured to detect the presence of passengers and/or load, wherein each respective sensor is in communication with the computing system.

12. The elevator hover mode control system of claim 10, further comprising at least one load detector within the elevator car, wherein the potential load change information includes at least a portion of the detected current load, wherein the at least a portion of the detected current load comprises an estimation of the amount of load that will exit the elevator car at a next stop.

13. The elevator hover mode control system of claim 10, wherein the hover mode of operation comprises:
detecting a vertical position of an elevator car within an elevator shaft relative to a landing; and
controlling the elevator machine to maintain the vertical position of the elevator car within the elevator shaft.

14. The elevator hover mode control system of claim 10, wherein the computing system is configured to operate the elevator system in a normal mode of operation when it is determined that the hover mode of operation is not required.

15. The elevator hover mode control system of claim 10, wherein the determination regarding the hover mode of operation comprises:
estimating a potential change in load based on the detected potential load change from the at least one sensor, wherein the estimated potential load change includes an estimated change in load that will transfer from the landing onto the elevator car.

16. The elevator hover mode control system of claim 10, the computing system further configured to compare the estimated change in load that will transfer to a threshold value.

17. The elevator hover mode control system of claim 16, wherein the threshold value is a predetermined value such that at any values above the threshold value, car displacement will exceed a specified stopping tolerance and hovering mode will be activated and any values below the threshold value, car displacement will not exceed the specified stopping tolerance and hovering mode will not be activated.

18. The elevator hover mode control system of claim 10, further comprising one or more elevator car sensors located on the elevator car configured to detect the presence of passengers and/or cargo located within the elevator car, wherein the potential load change information further includes information received from the one or more elevator car sensors.

19. The elevator hover mode control system of claim 10, further comprising:
a landing detection sensor configured to detect a current landing of the elevator car; and
the determination regarding the hover mode of operation is further based on the detected current landing.

20. The elevator hover mode control system of claim 10, wherein the sensor is at least one of a visual detection sensor or a time of flight depth sensor.
